(19) United States
(12) Patent Application Publication
(10) Pub. No.: US 2015/0201393 A1
(43) Pub. Date: Jul. 16, 2015

(54) DEVICES, SYSTEMS AND METHODS OF LOCATION IDENTIFICATION

(71) Applicant: Acer Incorporated, New Taipei City (TW)

(72) Inventors: Po-Jen Tu, New Taipei City (TW); Jia-Ren Chang, New Taipei City (TW); Ming-Chun Fang, New Taipei City (TW); Chun-Chi Ho, New Taipei City (TW); Chia-Hsun Lee, New Taipei City (TW); Wen-Cheng Hsu, New Taipei City (TW); Chao-Kuang Yang, New Taipei City (TW)

(21) Appl. No.: 14/338,716

(22) Filed: Jul. 23, 2014

(30) Foreign Application Priority Data
Jan. 14, 2014 (TW) 103101237

(51) Int. Cl. H04W 64/00; H04W 4/02

(52) U.S. Cl. CPC H04W 64/00; H04W 4/02

(57) ABSTRACT

A location identification device, adopted in an audio output device outputting an audio signal, includes a first audio receiving device, a second audio receiving device, and a processor. The first audio receiving device samples the audio signal by a sampling frequency to generate first sample points. A waveform of the audio signal is a superposition result of a high frequency signal and an envelope. The second audio receiving device, which is away from the first audio receiving device at a predetermined distance, samples the audio signal by the sampling frequency to generate second sample points. The processor obtains the first envelope of a first characteristic value and the second envelope of a second characteristic value for identifying a location of the audio output device according to a time difference and an amplitude difference between the first characteristic value and the second characteristic value.

### CROSS REFERENCE TO RELATED APPLICATIONS

This Application claims priority of Taiwan Patent Application No. 103101237, filed on Jan. 14, 2014, the entirety of which is incorporated by reference herein.

### BACKGROUND OF THE INVENTION

1. Field of the Invention

The disclosure relates generally to devices, systems, and methods for identifying location, and more particularly it relates to devices, systems, and methods for identifying location by a high-frequency audio signal.

2. Description of the Related Art

With the rapid progress of electrical devices and the popularity of tablet computers, mobile electronic devices have begun to exhibit the phenomenon of having the display module separated from the host. Therefore, there is a demand for the display module and the host to identify each other after separation. For properly meeting this demand, the technology of adaptive beamforming is the most popular technology for a machine to identify the location of another machine. Generally speaking, we expect to identify the location of another machine by a high-frequency audio signal that human ears can't hear. The technology of adaptive beamforming is based on two audio receiving devices receiving the audio signal that is generated by a machine and then identifying the location of the machine by the phase difference between the audio signals that the two audio receiving devices received.

It is assumed that the frequency of the audio signal generated by the machine is F_{S}, the sampling frequency of two audio receiving devices is F_{R}, the predetermined distance between the two audio receiving devices is D, and the sound speed is V_{S}. Therefore, the limitation of the identification method is

$$\frac{{F}_{s} \times D}{{V}_{s}} < 1$$

such that only the audio signal with a middle and low frequency can be adopted (that is, less than 4 kHz). It does not match our expectation that we want to adopt a high-frequency audio signal that human ears can't hear. In addition, the normal sampling frequency is usually greater than 10 times the frequency of sound. When adopting an audio signal of a high frequency, the complication of the system is increased due to an excessively high sampling frequency. Therefore, we need a location identification device and method which is able to adopt an audio signal of high frequency.

### BRIEF SUMMARY OF THE INVENTION

For solving above problems, the invention provides a location identification device, system, and method for identifying location by an audio signal of a high frequency.

In an embodiment, the invention provides a location identification device. The location identification device is adopted in an audio output device, which comprises a first audio receiving device, a second audio receiving device, and a processor. The first audio receiving device samples the audio signal by a sampling frequency to generate a plurality of first sample points. The waveform of the audio signal is a superposition result of a high-frequency signal and an envelope of a characteristic value. The second audio receiving device is separated from the first audio receiving device by a predetermined distance. The second audio receiving device samples the audio signal by the sampling frequency to generate a plurality of second sample points. The processor obtains the first envelope of a first characteristic value according to the first sampling points, and obtains the second envelope of a second characteristic value according to the second sampling points. The processor identifies a location of the audio output device according to the time difference and the amplitude difference between the first characteristic value and the second characteristic value.

In an embodiment, the invention further provides a location identification system. The location identification system comprises an audio output device, a location identification device, and a processor. The audio output device outputs an audio signal. The waveform of the audio signal is a superposition result of a high frequency signal and an envelope of a characteristic value. The location identification device comprises a first audio receiving device and a second audio receiving device. The first audio receiving device samples the audio signal by a sampling frequency to generate a plurality of first sample points. The second audio receiving device is separated from the first audio receiving device by a predetermined distance. The second audio receiving device samples the audio signal by the sampling frequency to generate a plurality of second sample points. The processor obtains the first envelope of a first characteristic value according to the first sampling points, and obtains the second envelope of a second characteristic value according to the second sampling points. The processor identifies the location of the audio output device according to the time difference and amplitude difference between the first characteristic value and the second characteristic value.

In an embodiment, the invention further provides a location identification method. The location identification method is adopted in an audio output device which outputs an audio signal. The location identification method comprises sampling the audio signal to generate a plurality of first sample points by a first audio receiving device with a sampling frequency, in which a waveform of the audio signal is a superposition result of a high frequency signal and an envelope of a characteristic value; sampling the audio signal to generate a plurality of second sample points by a second audio receiving device with the sampling frequency, wherein the second audio receiving device is away from the first audio receiving device at a predetermined distance; obtaining a first envelope according to the first sampling points, in which the first envelope comprises a first characteristic value; obtaining a second envelope according to the second sampling points, in which the second envelope comprises a second characteristic value; and identifying the location from which the audio signal is generated according to the time difference and the amplitude difference between the first characteristic value and the second characteristic value.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic of the location identification system 100 in accordance with an embodiment of the invention;

FIG. 2 is a waveform of the high frequency signal of the audio signal S_{A} in accordance with an embodiment of the invention;

FIG. 3 is a waveform of the envelope of the audio signal S_{A} in accordance with an embodiment of the invention;

FIG. 4 is a waveform of a superposition result of the high frequency signal of FIG. 2 and the envelope of FIG. 3 with a plurality of sampling points in accordance with an embodiment of the invention;

FIG. 5 is a waveform of the audio signal received by the first audio receiving device 121 in accordance with an embodiment of the invention;

FIG. 6 is a schematic diagram of a method for reducing noise in accordance with an embodiment of the invention; and

FIG. 7 is a flow chart of the location identification method in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

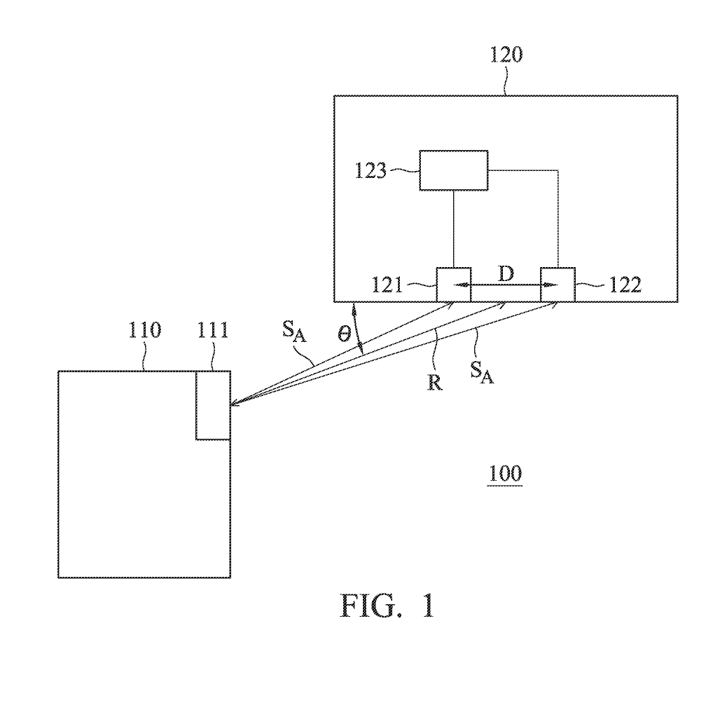

FIG. 1 is a schematic of the location identification system 100 in accordance with an embodiment of the invention. As shown in FIG. 1, the location identification system 100 includes the first device 110 and the second device 120. The first device 110 includes the audio output device 111. The audio output device 111 is used to output the audio signal S_{A}. the second device 120 includes the first audio receiving device 121, the second audio receiving device 122, and the processor 123. The first audio receiving device 121 is away from the second audio receiving device 122 at a predetermined distance D. The distance between the audio output device 111 and the middle point of the first audio receiving device 121 and the second audio receiving device 122 is R, and the angle is θ. The processor 123 of the second device 120 identifies the position of the audio output device 111 of the first device 110 according to the time difference and the amplitude difference between the audio signal S_{A} respectively received by the first audio receiving device 121 and the second audio receiving device 122.

For the sake of clarifying the technical features of the invention in detail, the description below is stated according to a better embodiment of the invention. According to an embodiment of the invention, the audio output device 111 of FIG. 1 outputs the audio signal S_{A} which is a superposition result of a high frequency signal and an envelope.

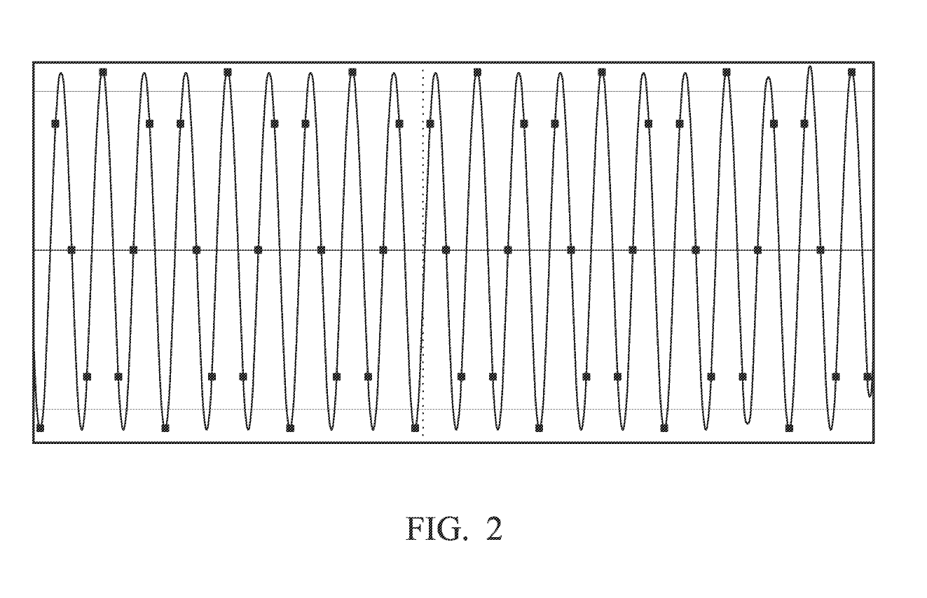

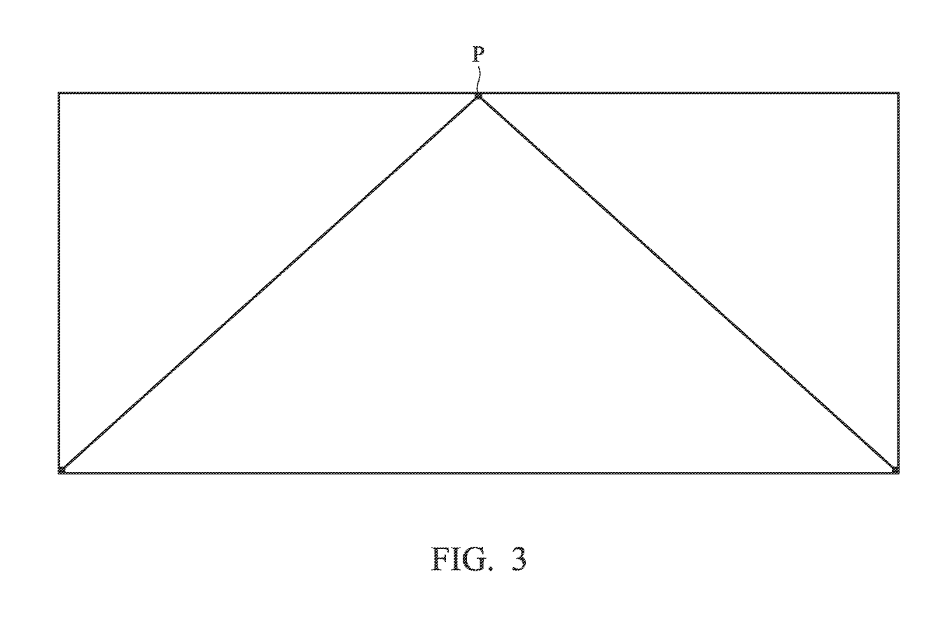

FIG. 2 is a waveform of the high frequency signal of the audio signal S_{A} in accordance with an embodiment of the invention. As shown in FIG. 2, the high frequency signal is a sinusoidal wave of a fixed frequency F_{S}. FIG. 3 is a waveform of the envelope of the audio signal S_{A} in accordance with an embodiment of the invention. As shown in FIG. 3, the envelope has a characteristic value P, and the envelope is defined as w[j].

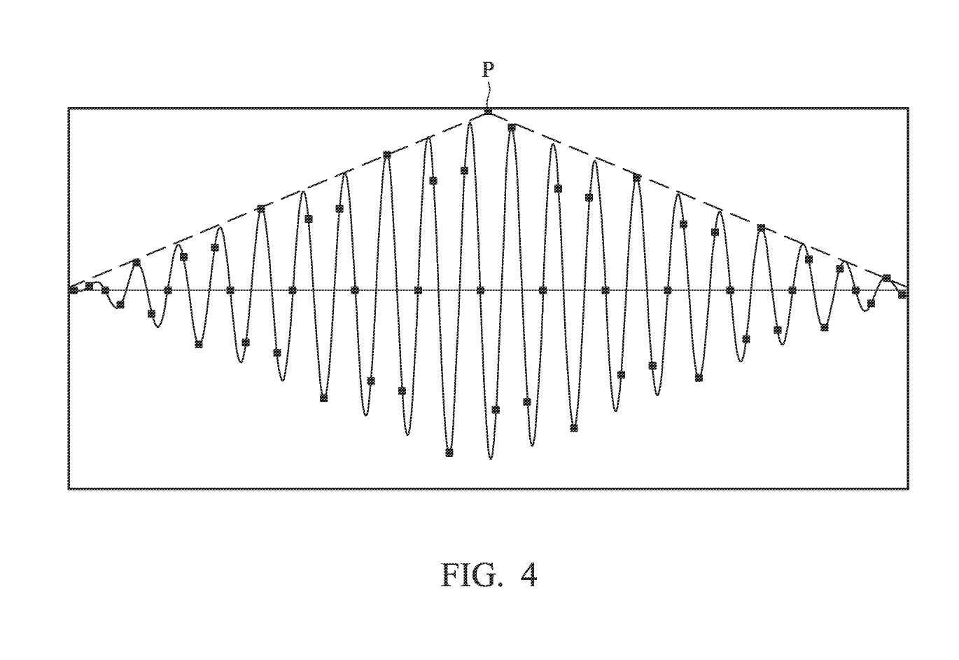

FIG. 4 is a waveform of a superposition result of the high frequency signal of FIG. 2 and the envelope of FIG. 3 with a plurality of sampling points in accordance with an embodiment of the invention. As shown in FIG. 4, the superposition result of the high frequency signal of FIG. 2 and the envelope of FIG. 3 is a signal that is fading in at the beginning and then fading out. The processor 123 of FIG. 1 recovers the characteristic point P of FIG. 4 that is received by the first audio receiving device 121 and the second audio receiving device 122 by a math calculation. The processor 123 of FIG. 1 further identifies the location of the audio output device 111 according to the time difference and the amplitude difference between the characteristic point P of FIG. 4 that is received by the first audio receiving device 121 and the characteristic point P that is received by the second audio receiving device 122.

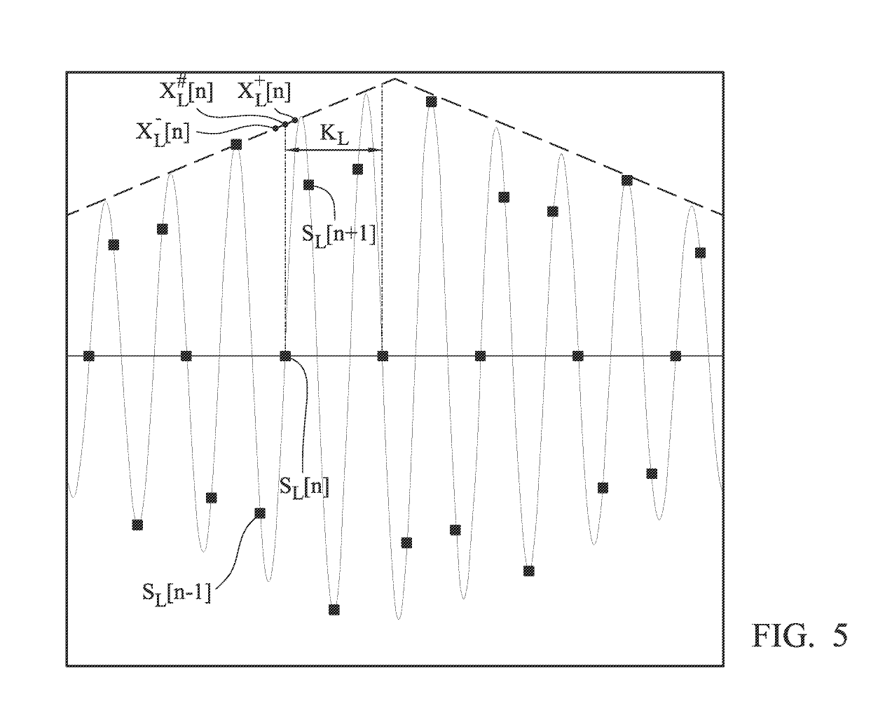

The following will be explained for the first audio receiving device 121, and the action of the second audio receiving device 122 is the same. FIG. 5 is a waveform of the audio signal received by the first audio receiving device 121 in accordance with an embodiment of the invention.

$$\begin{matrix}{x}_{L}^{+} [ n ] = {[ {s}_{L}^{2} [ n ] + {( \frac{{s}_{L} [ n + 1 ] - {s}_{L} [ n ] \times COS ( 2 π {F}_{S} / {F}_{R} )}{SIN ( 2 π {F}_{S} / {F}_{R} )} )}^{2} ]}^{0.5} & ( Eq . 1 ) \\ {x}_{L}^{-} [ n ] = {[ {s}_{L}^{2} [ n ] + {( \frac{{s}_{L} [ n - 1 ] - {s}_{L} [ n ] \times COS ( 2 π {F}_{S} / {F}_{R} )}{SIN ( - 2 π {F}_{S} / {F}_{R} )} )}^{2} ]}^{0.5} & ( Eq . 2 ) \\ {x}_{L}^{\#} [ n ] = {[ {( \frac{{s}_{L} [ n + 1 ] + {s}_{L} [ n - 1 ]}{2 COS ( 2 π {F}_{S} / {F}_{R} )} )}^{2} + {( \frac{{s}_{L} [ n + 1 ] - {s}_{L} [ n - 1 ]}{2 SIN ( 2 π {F}_{S} / {F}_{R} )} )}^{2} ]}^{0.5} & ( Eq . 3 ) \\ {x}_{L}^{*} [ n ] = \sqrt{{x}_{L}^{+} [ n ] \times {x}_{L}^{-} [ n ]} - 2 {x}_{L}^{\#} [ n ] & ( Eq . 4 ) \\ {x}_{L}^{*} [ {K}_{L} ] = MAX \{ {x}_{L}^{*} [ n ] \} & ( Eq . 5 )\end{matrix}$$

As shown in FIG. 5, the processor 123 obtains x_{L}⁺[n] of the envelope of FIG. 5 according to s_{L}[n], s_{L}[n+1], and Eq. 1, and obtains x_{L}⁻[n] of the envelope according to s_{L}[n], s_{L}[n−1], and Eq. 2. Then, the processor 123 further obtains x_{L}^{#}[n] by Eq. 3. When x_{L}^{#}[n] is located at the characteristic point P, the processor 123 will fix x_{L}^{#}[n] to be x_{L}*[n] by Eq. 4 and obtain the maximum amplitude x_{L}*[n] corresponding to each time period. The half interval K_{L} can be calculated with Eq. 5.

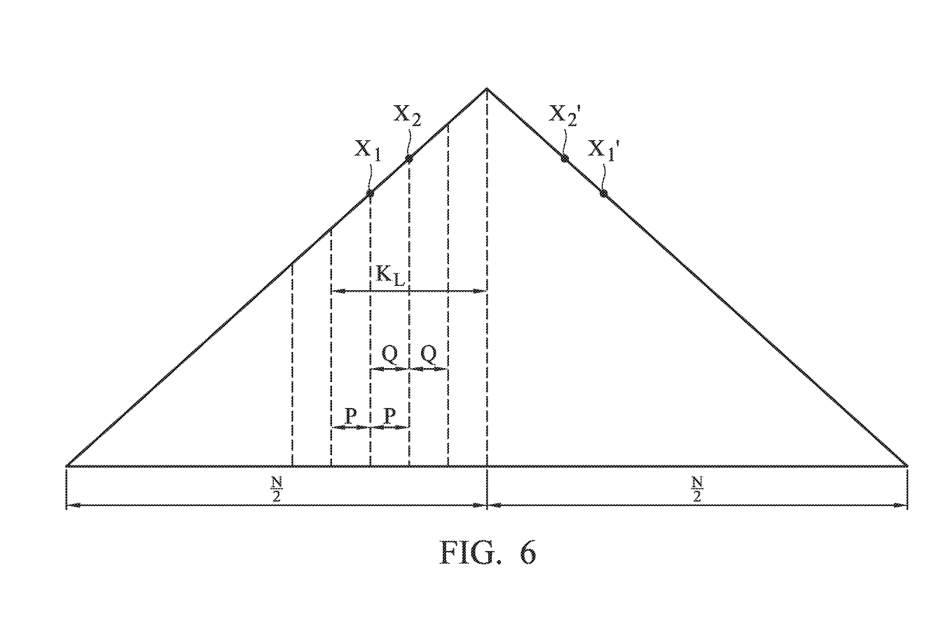

After finding the possible range of the characteristic value by using Eq. 1 to Eq. 5, Eq. 6 and Eq. 7 are further adopted to average twice for eliminating the influence of noise. FIG. 6 is a schematic diagram of a method for reducing noise in accordance with an embodiment of the invention.

$$\begin{matrix}{B}_{L} [ m , {j}_{L} ] = \frac{1}{2 P + 1} {\sum }_{p = - P}^{P} {x}_{L}^{*} [ {K}_{L} + {j}_{L} + m + p ] \times \frac{W [ N / 2 + m ]}{W [ N / 2 + m + p ]} & ( Eq . 6 ) \\ {B}_{L}^{*} [ u , {j}_{L} ] = \frac{1}{2 Q + 1} {\sum }_{q = - Q}^{Q} {B}_{L} [ u + q , {j}_{L} ] \times \frac{W [ N / 2 + u ]}{W [ N / 2 + u + q ]} & ( Eq . 7 )\end{matrix}$$

As shown in FIG. 6, it is assumed that there are N sample points in an envelope interval, and there are thus N/2 sample points in each fade-in and fade-out internals. The half interval K_{L} can be found. When carrying out the first averaging by Eq. 6, taking the point X₁ for example, the points on the range of plus and minus P internal around the point X₁ are used to find an average, and the calculation is also carried out along the envelope of FIG. 6 from the point X₁ to the point X₁′. When carrying out the second averaging by Eq. 7, the points on the range of plus and minus Q internal around the point X₂ are used to average, and the calculation is also carried out along the envelope of FIG. 6 from the point X₂ to the point X₂′.

According to an embodiment of the invention, the obtained K_{L} is 50, and both P and Q specified by the user are 20. That is, m of Eq. 6 is K_{L}+P, which is 70, and u of Eq. 7 is K_{L}−Q, which is 30.

Then, B_{L}*[u, j_{L}] is compared to the envelope w[j], and the corresponding time J_{L}^{m} of the received characteristic point can be obtained by Eq. 8, Eq. 10, and Eq. 11. The amplitude of the received characteristic point can be obtained by Eq. 9.

$$\begin{matrix}{G}_{L} [ u , {j}_{L} ] = \frac{{B}_{L}^{*} [ u , {j}_{L} ]}{W [ N / 2 + u ]} & ( Eq . 8 ) \\ {AVG}_{L} [ {j}_{L} ] = \frac{1}{2 ( M - Q ) + 1} {\sum }_{u = - ( M - Q )}^{M - Q} {G}_{L} [ u , {j}_{L} ] & ( Eq . 9 ) \\ {MSG}_{L} [ {j}_{L} ] = \frac{1}{2 ( M - Q ) + 1} {\sum }_{u = - ( M - Q )}^{M - Q} {( {G}_{L} [ u , {j}_{L} ] - {AVG}_{L} [ {j}_{L} ] )}^{2} & ( Eq . 10 ) \\ {MSG}_{L} [ {j}_{L}^{m} ] = MIN \{ {MSG}_{L} [ {j}_{L} ] \} & ( Eq . 11 )\end{matrix}$$

Similarly, the time j_{R}^{m} received by the second receiving device 122 and the amplitude received by the second receiving device 122 can be obtained by the same method described above, and the time difference and the amplitude difference between the characteristic points received by the first audio receiving device 121 and the second audio receiving device 122 can be obtained by Eq. 12 and Eq. 13.

$$\begin{matrix}{n}^{*} = ( {K}_{L} + {j}_{L}^{m} ) - ( {K}_{R} + {j}_{R}^{m} ) & ( Eq . 12 ) \\ {A}^{*} = \frac{{AVG}_{L} [ {j}_{L}^{m} ]}{{AVG}_{R} [ {j}_{R}^{m} ]} & ( Eq . 13 )\end{matrix}$$

According to an embodiment of the invention, n_{Y}* and A_{Y}* are the means of 30 sets of n* and A* respectively. The distance between the audio output device 111 and the first audio receiving device 121 is obtained by Eq. 14, and the distance between the audio output device 111 and the second audio receiving device 122 is obtained by Eq. 15. Then, the distance R and the angle θ are obtained by Eq. 16 and Eq. 17 respectively.

$$\begin{matrix}{R}_{L} = \frac{{n}_{Y}^{*} \times {V}_{S}}{( 1 - \sqrt{{A}_{Y}^{*}} ) \times {F}_{R}} & ( Eq . 14 ) \\ {R}_{R} = \frac{{n}_{Y}^{*} \times {V}_{S}}{( \sqrt{1 / {A}_{Y}^{*}} - 1 ) \times {F}_{R}} & ( Eq . 15 ) \\ R = 0.5 \sqrt{2 {R}_{R}^{2} + 2 {R}_{L}^{2} - {D}^{2}} & ( Eq . 16 ) \\ θ = {COS}^{- 1} ( \frac{{R}_{R}^{2} - {R}_{L}^{2}}{2 R \times D} ) & ( Eq . 17 )\end{matrix}$$

According to an embodiment of the invention, for the location identification system stated above, the signal frequency F_{S} is 18 kHz, and the sampling frequency F_{R} of two audio receiving devices is 48 kHz, under the assumption that the operating temperature is 20 degrees and the speed of sound is 343 m/s. Therefore, the invention mitigates

$$\frac{{F}_{S} \times D}{{V}_{s}} = 3.67$$

and the sampling frequency is 2.66 times the signal frequency, which greatly breaks through the limitations of previous technology.

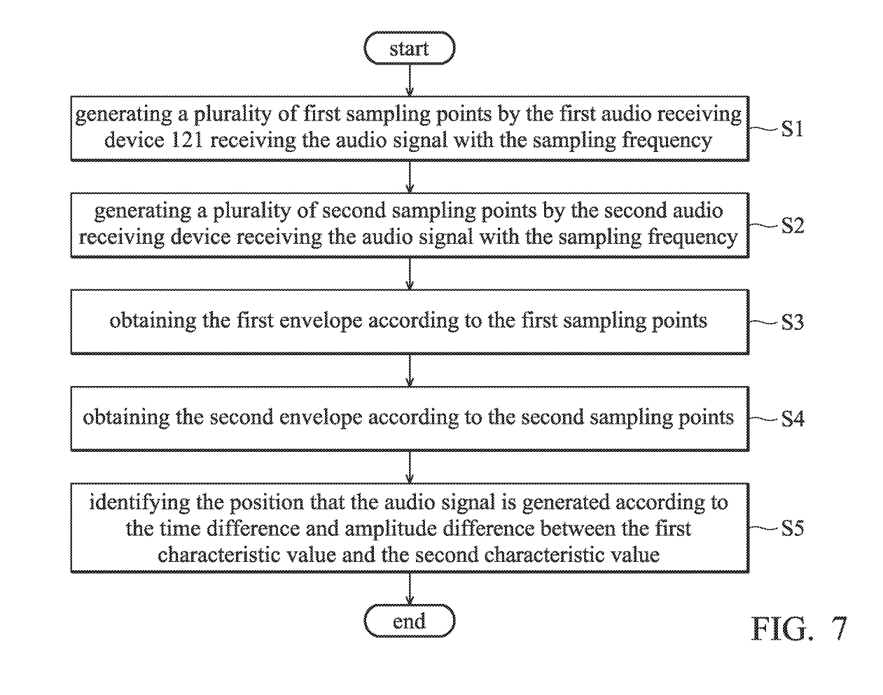

FIG. 7 is a flow chart of the location identification method in accordance with an embodiment of the invention. As shown in FIG. 7, a plurality of first sampling points are generated by the first audio receiving device 121 receiving the audio signal with the sampling frequency (Step S1). The waveform of the audio signal is a superposition result of a high frequency signal and an envelope which includes a characteristic value. A plurality of second sampling points are generated by the second audio receiving device 122 receiving the audio signal with the sampling frequency (Step S2). The distance between the first audio receiving device 121 and the second audio receiving device 122 is the predetermined distance D. The first envelope is obtained according to the first sampling points (Step S3). The second envelope is obtained according to the second sampling points (Step S4). The first envelope includes a first characteristic value, and the second envelope includes a second characteristic value. The position that the audio signal is generated is identified according to the time difference and amplitude difference between the first characteristic value and the second characteristic value (Step S5).

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A location identification device, adopted in an audio output device outputting an audio signal, comprising:
a first audio receiving device sampling the audio signal by a sampling frequency to generate a plurality of first sample points, wherein a waveform of the audio signal is a superposition result of a high frequency signal and an envelope of a characteristic value;
a second audio receiving device, away from the first audio receiving device at a predetermined distance, sampling the audio signal by the sampling frequency to generate a plurality of second sample points; and
a processor obtaining the first envelope of a first characteristic value according to the first sampling points and obtaining the second envelope of a second characteristic value according to the second sampling points, wherein the processor identifies a location of the audio output device according to a time difference and an amplitude difference between the first characteristic value and the second characteristic value.

2. The location identification device of claim 1, wherein a ratio of a product of the sampling frequency by the predetermined distance to a sound speed is greater than 1.

3. The location identification device of claim 2, wherein the sampling frequency is less than 10 times the frequency of the audio signal.

4. A location identification system comprising:
an audio output device outputting an audio signal, wherein a waveform of the audio signal is a superposition result of a high-frequency signal and an envelope of a characteristic value;
a location identification device comprising:
a first audio receiving device sampling the audio signal by a sampling frequency to generate a plurality of first sample points; and
a second audio receiving device, away from the first audio receiving device at a predetermined distance, sampling the audio signal by the sampling frequency to generate a plurality of second sample points; and
a processor obtaining the first envelope of a first characteristic value according to the first sampling points and obtaining the second envelope of a second characteristic value according to the second sampling points, wherein the processor identifies a location of the audio output device according to a time difference and an amplitude difference between the first characteristic value and the second characteristic value.

5. The location identification system of claim 4, wherein a ratio of a product of the sampling frequency by the predetermined distance to a sound speed is greater than 1.

6. The location identification system of claim 4, wherein the sampling frequency is less than 10 times the frequency of the audio signal.

7. A location identification method, adopted in an audio output device outputting an audio signal, comprising:
sampling the audio signal to generate a plurality of first sample points by a first audio receiving device with a sampling frequency, wherein a waveform of the audio signal is a superposition result of a high frequency signal and an envelope of a characteristic value;
sampling the audio signal to generate a plurality of second sample points by a second audio receiving device with the sampling frequency, wherein the second audio receiving device is away from the first audio receiving device at a predetermined distance;
obtaining a first envelope according to the first sampling points, wherein the first envelope comprises a first characteristic value;
obtaining a second envelope according to the second sampling points, wherein the second envelope comprises a second characteristic value; and
identifying a location from which the audio signal is generated according to a time difference and an amplitude difference between the first characteristic value and the second characteristic value.

8. The location identification method of claim 7, wherein a ratio of a product of the sampling frequency by the predetermined distance to a sound speed is greater than 1.

9. The location identification method of claim 7, wherein the first characteristic value and the second characteristic value are generated by averaging the results of several calculations.
